(19) United States
(12) Patent Application Publication
(10) Pub. No.: US 2026/0167761 A1
(43) Pub. Date: Jun. 18, 2026

(54) METHOD FOR PRODUCING WATER-BASED MOISTURE-PERMEABLE WATERPROOF MATERIALS AND WATER-BASED MOISTURE-PERMEABLE WATERPROOF RESIN

(71) Applicant: NAN YA PLASTICS CORPORATION, TAIPEI (TW)

(72) Inventors: CHING-YAO YUAN, TAIPEI (TW); CHENG-LI CHAO, TAIPEI (TW); CHIA-LUNG TSAI, TAIPEI (TW)

(21) Appl. No.: 19/051,181

(22) Filed: Feb. 12, 2025

(30) Foreign Application Priority Data
Dec. 18, 2024 (TW) 113149270

(51) Int. Cl. C08G 18/12; C08G 18/30; C08G 18/32; C08G 18/48; C08K 3/34; D06N 3/14

(52) U.S. Cl. CPC C08G 18/12; C08G 18/302; C08G 18/3212; C08G 18/3228; C08G 18/4808; C08G 18/4812; C08G 18/4845; C08K 3/346; D06N 3/146; D06N 2203/068; D06N 2205/023; D06N 2209/121; D06N 2211/10

(57) ABSTRACT

A method for producing water-based moisture-permeable waterproof materials and water-based moisture-permeable waterproof resin. The method for producing water-based moisture-permeable waterproof materials includes: adding kaolin to a water-based polyurethane to form a resin mixture; stirring the resin mixture to form pores in the resin mixture; and applying the resin mixture onto a substrate layer and performing heat-drying on the resin mixture. The water-based polyurethane includes polyether polyols, isocyanates, and 1,4-cyclohexanedimethanol polymerized to form a polyurethane resin with a cyclic structure. An addition amount of the kaolin is 3% to 8%.

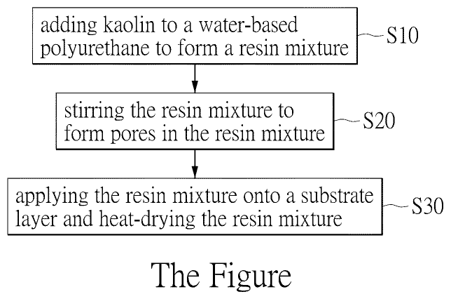

### CROSS-REFERENCE TO RELATED PATENT APPLICATION

This application claims the benefit of priority to the Taiwan Patent Application No. 113149270, filed on Dec. 18, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a material and a resin composition, and more particularly to a method for producing water-based moisture-permeable waterproof materials and water-based moisture-permeable waterproof resin.

### BACKGROUND OF THE DISCLOSURE

In the related art, the foam layer of polyurethane synthetic leather is made by a wet coagulation process and then bonded through a dry method. The wet coagulation process uses dimethylformamide (DMF) and water as a substitution for creating pores and solidifying the resin. As a result, the residual DMF solvent in the leather material, combined with the large amount of water consumed during the foaming process, generates a significant amount of industrial wastewater contaminated with DMF, which causes environmental pollution.

In order to reduce environmental pollution, water-based polyurethane has gradually replaced the need for the wet coagulation process and is widely used in various applications such as textile coating, leather processing, adhesives, sealants, and plastic molding. The water-based polyurethane is synthesized by reacting polyether or polyester polyols with isocyanates, resulting in a high-viscosity pre-polymer with NCO-functional groups at the ends. However, the waterproof moisture-permeable properties of water-based polyurethane still have room for improvement.

Therefore, how to improve on the process and formulation of producing waterproof moisture-permeable resin, in order to overcome the aforementioned problems, has become one of the important issues to be solved in the related art.

### SUMMARY OF THE DISCLOSURE

In response to the above-referenced technical inadequacies, the present disclosure provides a method for producing water-based moisture-permeable waterproof materials and water-based moisture-permeable waterproof resin.

In order to solve the above-mentioned problems, one of the technical aspects adopted by the present disclosure is to provide a method for producing water-based moisture-permeable waterproof materials, including: adding kaolin to a water-based polyurethane to form a resin mixture; stirring the resin mixture to form pores in the resin mixture; and applying the resin mixture onto a substrate layer and heat-drying the resin mixture. The water-based polyurethane includes polyether polyols, isocyanates, and 1,4-cyclohexanedimethanol polymerized to form a polyurethane resin with a cyclic structure. An addition amount of the kaolin is 3% to 8%.

In one of the possible or preferred embodiments, the resin mixture is stirred at a speed of 1000 to 1200 rpm for 10 to 15 minutes.

In one of the possible or preferred embodiments, the heat-drying is performed at a temperature of 100° C. to 120° C. for 15 to 20 minutes.

In order to solve the above-mentioned problems, another one of the technical aspects adopted by the present disclosure is to provide a water-based moisture-permeable waterproof resin, including: a water-based polyurethane comprising polyether polyols, isocyanates, and 1,4-cyclohexanedimethanol polymerized to form a polyurethane resin with a cyclic structure; and kaolin. An addition amount of the kaolin is 3% to 8%.

In one of the possible or preferred embodiments, a particle size (D90) distribution range of the water-based moisture-permeable waterproof resin is from 180 nm to 215 nm.

In one of the possible or preferred embodiments, a viscosity of the water-based moisture-permeable waterproof resin is between 10,000 cps and 100,000 cps.

In one of the possible or preferred embodiments, based on a total weight of the water-based polyurethane being 100 wt %, the water-based polyurethane includes: 20 wt % to 30 wt % of polyether polyol; 10 wt % to 15 wt % of isocyanate; 0.1 wt % to 2 wt % of 1,4-cyclohexanedimethanol; 1 wt % to 2 wt % of 2,2-dihydroxyethylacrylate; 0.5 wt % to 1 wt % of chain extender; 1 wt % to 2 wt % of triethylamine; and 50 wt % to 65 wt % of water.

In one of the possible or preferred embodiments, the isocyanate is a diisocyanate, and the diisocyanate is selected from the group consisting of toluene diisocyanate (TDI), isophorone diisocyanate (IPDI), methylene diphenyl diisocyanate (MDI), and hexamethylene diisocyanate (HMDI).

In one of the possible or preferred embodiments, a molecular weight of the polyether polyol is between 200 g/mol and 6000 g/mol.

In one of the possible or preferred embodiments, the chain extender is selected from the group consisting of ethylenediamine, hexamethylenediamine, xylenediamine, isophoronediamine, diethylenetriamine, and N-aminoethyl-N-ethanolamine.

Therefore, in the method for producing water-based moisture-permeable waterproof materials and water-based moisture-permeable waterproof resin provided by the present disclosure, by virtue of “the water-based polyurethane including polyether polyols, isocyanates, and 1,4-cyclohexanedimethanol polymerized to form a polyurethane resin with a cyclic structure,” and “an addition amount of the kaolin being 3% to 8%,” the moisture-permeable waterproof properties of the resin material can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawing, in which:

The figure is a flowchart of method for producing water-based moisture-permeable waterproof materials of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Referring to the figure, the present disclosure provides a method for producing water-based moisture-permeable waterproof materials, which includes: step S10: adding kaolin to a water-based polyurethane to form a resin mixture, step S20: stirring the resin mixture to form pores in the resin mixture, step S30: applying the resin mixture onto a substrate layer and heat-drying the resin mixture. The method for producing water-based moisture-permeable waterproof materials of the present disclosure is a mechanical foaming process, which is different from the traditional wet coagulation process and is more sustainable and environmentally friendly.

The water-based polyurethane of the present disclosure may be synthesized by polymerizing polyether polyols, isocyanates, and 1,4-cyclohexanedimethanol to form a polyurethane resin with a cyclic structure. Specifically, the polyether polyol and 1,4-cyclohexanedimethanol may be vacuum-dehydrated and then added to the reaction vessel, where the temperature is raised to 70 to 80° C. using an oil bath. Then, isocyanate is added to the reaction vessel and processing the synthesis reaction for 2 hours, and 2,2-bis(hydroxymethyl) propionic acid (DMPA) is added and reacting for 1.5 hours to obtain the prepolymer. Thereafter, the prepolymer is cooled to 60° C., triethylamine (TEA) is added, and the reaction continues for 25 to 40 minutes. Then, at a speed of 500 rpm, deionized water is added, followed by the addition of a chain extender for a chain extension reaction of about 30 minutes to obtain the water-based polyurethane.

The molecular weight of the polyether polyol may range from 200 g/mol to 6000 g/mol. The polyether polyol may be selected from the group consisting of di-functional polyether polyol PPG (DL3000), tri-functional polyether polyol PPG (P3000), and di-functional polyether polyol PTMG (PTMG2000). The di-functional polyether polyol PPG may be a polyol produced using a potassium hydroxide (KOH) or dimethyl carbonate (DMC) catalyst system, with ethylene oxide and propylene oxide as initiators, having a molecular weight of 3000 g/mol to 6000 g/mol. The tri-functional polyether polyol PPG is a polyol produced using a KOH or DMC catalyst system, with ethylene oxide and propylene oxide as initiators, and having a molecular weight of 3000 g/mol to 6000 g/mol. The di-functional polyether polyol PTMG is a polyether polyol made from THE as the raw material, with properties such as hydrolysis resistance, low-temperature flexibility, and bacteriostatic characteristics, and having a molecular weight of 250 g/mol to 2000 g/mol.

In one embodiment of the present disclosure, the content of polyether polyol may range from 20 wt % to 30 wt % (for example, any integer value between 20 and 30 (wt %)). The content of di-functional polyether polyol PPG may range from 10 wt % to 20 wt % (for example, any integer value between 10 and 20 (wt %)); the content of di-functional polyether polyol PTMG may range from 5 wt % to 10 wt % (for example, any integer value between 5 and 10 (wt %)); and the content of tri-functional polyether polyol PPG may range from 1 wt % to 5 wt % (for example, any integer value between 1 and 5 (wt %)).

It should be noted that in order to meet the requirements for hydrolysis resistance and waterproofing, the contents of di-functional polyether polyol PPG and di-functional polyether polyol PTMG are both greater than the content of tri-functional polyether polyol PPG. However, in order to balance hydrostatic pressure resistance and moisture permeability, tri-functional polyether polyol PPG may be added to reinforce the network structure for improved waterproofing. The content of tri-functional polyether polyol PPG may range from 1 wt % to 5 wt %. If the content of tri-functional polyether polyol PPG is less than 1 wt %, the hydrostatic pressure resistance will degrade due to the low crosslinking density.

Preferably, the isocyanate is a diisocyanate. The diisocyanate may be toluene diisocyanate (TDI), methylene diphenyl diisocyanate (MDI), isophorone diisocyanate (IPDI), xylylene diisocyanate (XDI), tetramethylxylene diisocyanate, 4,4′-Methylene dicyclohexyl diisocyanate (H12MDI), or trimethylhexamethylene diisocyanate (TMDI). Preferably, diisocyanate is isophorone diisocyanate (IPDI) or 4,4′-Methylene dicyclohexyl diisocyanate (H12MDI) including ring structure. In one embodiment, the content of isocyanate may be 10 wt % to 15 wt % (for example, any integer value between 10 and 15 (wt %)).

1,4-cyclohexanedimethanol (CHDM) is a structurally symmetrical alicyclic diol. The water-based polyurethane of the present disclosure contains 1,4-cyclohexanedimethanol, which provides improved chemical stability, transparency, and toughness. In one embodiment, the content of 1,4-cyclohexanedimethanol may be 0.1 wt % to 2 wt % (for example, any integer value between 0.1 and 2 (wt %)). It is worth mentioning that both 1,4-cyclohexanedimethanol and polyether polyols have hydrophobic structures, which can enhance water resistance. Additionally, micropores are generated through mechanical foaming to achieve moisture-permeable waterproofing. The structure of 1,4-cyclohexanedimethanol is shown below.

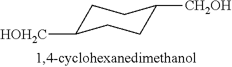

In addition, in order to enhance the stability of the water-based polyurethane and its moisture permeability during film formation, 2,2-dimethylol propionic acid (DMPA) needs to be added. Based on a total weight of the water-based polyurethane being 100 wt %, the content of 2,2-dimethylol propionic acid may be 1 wt % to 2 wt % (for example, any integer value between 1 and 2 (wt %)). In the present disclosure, the neutralizing agent is preferably triethylamine (TEA) in an amount of 1 wt % to 2 wt %. The DMPA with hydrophilic group provides an acid group to the prepolymer, which, when the neutralizing agent (TEA) is added later, allows the TEA to ionize with the acid, thereby facilitating water dispersion.

The chain extender may be a low molecular weight polyamine with a number average molecular weight of less than 500 g/mol. For example, the chain extender can be ethylenediamine (EDA), hexamethylenediamine (HMDA), xylylene diamine, isophorone diamine (IPDA), diethylenetriamine (DETA), or N-aminethyl-N-ethanolamine. However, the present disclosure is not limited to the aforementioned examples. Based on the total weight of the water-based polyurethane being 100 wt %, the water-based polyurethane includes 50 wt % to 65 wt % of water.

### Embodiment 1

14.5 wt % of di-functional polyether polyol PPG (DL3000), 8.2 wt % of di-functional polyether polyol PTMG (PTMG2000), 2.8 wt % of tri-functional polyether polyol PPG (P3000), and 0.6 wt % of 1,4-cyclohexanedimethanol (CHDM) are placed in the bottom of the reaction vessel, and then stirred uniformly and heated to 80° C. Then, 10.6 wt % of isophorone diisocyanate (IPDI) is added and reacted for 2 hours, and then 1.4 wt % of 2,2-dimethylolpropionic acid (DMPA) is added and reacted for 1.5 hours. After cooling to 60° C., 1.1 wt % of triethylamine (TEA) is added for ionization. Then, 59.9 wt % of water for dispersion and 0.9 wt % of ethylenediamine (EDA) are added to conduct the chain-extension reaction for about 30 minutes to obtain the water-based polyurethane.

### Embodiment 2

16.3 wt % of di-functional polyether polyol PPG (DL3000), 8.2 wt % of di-functional polyether polyol PTMG (PTMG2000), 1 wt % of tri-functional polyether polyol PPG (P3000), and 0.6 wt % of 1,4-cyclohexanedimethanol (CHDM) are placed in the bottom of the reaction vessel, and then stirred uniformly and heated to 80° C. Then, 10.6 wt % of isophorone diisocyanate (IPDI) is added and reacted for 2 hours, and then 1.4 wt % of 2,2-dimethylolpropionic acid (DMPA) is added and reacted for 1.5 hours. After cooling to 60° C., 1.1 wt % of triethylamine (TEA) is added for ionization. Then, 59.9 wt % of water for dispersion and 0.9 wt % of ethylenediamine (EDA) are added to conduct the chain-extension reaction for about 30 minutes to obtain the water-based polyurethane.

### Embodiment 3

14.5 wt % of di-functional polyether polyol PPG (DL3000), 8.8 wt % of di-functional polyether polyol PTMG (PTMG2000), and 2.8 wt % of tri-functional polyether polyol PPG (P3000) are placed in the bottom of the reaction vessel, and then stirred uniformly and heated to 80° C. Then, 10.6 wt % of isophorone diisocyanate (IPDI) is added and reacted for 2 hours, and then 1.4 wt % of 2,2-dimethylolpropionic acid (DMPA) is added and reacted for 1.5 hours. After cooling to 60° C., 1.1 wt % of triethylamine (TEA) is added for ionization. Then, 59.9 wt % of water for dispersion and 0.9 wt % of ethylenediamine (EDA) are added to conduct the chain-extension reaction for about 30 minutes to obtain the water-based polyurethane.

### Embodiment 4

14.5 wt % of di-functional polyether polyol PPG (DL3000), 7.2 wt % of di-functional polyether polyol PTMG (PTMG2000), 2.8 wt % of tri-functional polyether polyol PPG (P3000), and 1.6 wt % of 1,4-cyclohexanedimethanol (CHDM) are placed in the bottom of the reaction vessel, and then stirred uniformly and heated to 80° C. Then, 10.6 wt % of isophorone diisocyanate (IPDI) is added and reacted for 2 hours, and then 1.4 wt % of 2,2-dimethylolpropionic acid (DMPA) is added and reacted for 1.5 hours. After cooling to 60° C., 1.1 wt % of triethylamine (TEA) is added for ionization. Then, 59.9 wt % of water for dispersion and 0.9 wt % of ethylenediamine (EDA) are added to conduct the chain-extension reaction for about 30 minutes to obtain the water-based polyurethane.

### COMPARATIVE EXAMPLE

17.3 wt % of di-functional polyether polyol PPG (DL3000) and 8.8 wt % of di-functional polyether polyol PTMG (PTMG2000) are placed in the bottom of the reaction vessel, and then stirred uniformly and heated to 80° C. Then, 10.6 wt % of isophorone diisocyanate (IPDI) is added and reacted for 2 hours, and then 1.4 wt % of 2,2-dimethylolpropionic acid (DMPA) is added and reacted for 1.5 hours. After cooling to 60° C., 1.1 wt % of triethylamine (TEA) is added for ionization. Then, 59.9 wt % of water for dispersion and 0.9 wt % of ethylenediamine (EDA) are added to conduct the chain-extension reaction for about 30 minutes to obtain the water-based polyurethane.

The composition of the water-based polyurethane used in the present disclosure is shown in Table 1 (unit: wt %), and the water-based polyurethane resin is further applied to synthetic leather to test moisture permeability and water resistance. Both moisture permeability and water resistance tests are conducted with triplicate samples, and the average value is taken.

TABLE 1

| | molecular | | | | | |
|---|---|---|---|---|---|---|
| | weight | Comparative | | | | |
| material | (g/mol) | Example | Embodiment 1 | Embodiment 2 | Embodiment 3 | Embodiment 4 |
| DL3000 | 3000 | 17.3 | 14.5 | 16.3 | 14.5 | 14.5 |
| PTMG2000 | 2000 | 8.8 | 8.2 | 8.2 | 8.8 | 7.2 |
| P3000 | 3000 | 0 | 2.8 | 1 | 2.8 | 2.8 |
| DMPA | 134 | 1.4 | 1.4 | 1.4 | 1.4 | 1.4 |
| IPDI | 222 | 10.6 | 10.6 | 10.6 | 10.6 | 10.6 |
| CHDM | 144 | 0 | 0.6 | 0.6 | 0 | 1.6 |
| EDA | 60 | 0.9 | 0.9 | 0.9 | 0.9 | 0.9 |
| TEA | 105 | 1.1 | 1.1 | 1.1 | 1.1 | 1.1 |
| water | — | 59.9 | 59.9 | 59.9 | 59.9 | 59.9 |

| | | | | | |
|---|---|---|---|---|---|
| moisture | 6674 | 6182 | 6416 | 6362 | 5693 |
| permeability | | | | | |
| (g/m²*24 hr) | | | | | |
| water resistance | 1317 | 2140 | 1986 | 1544 | 2571 |
| (mmH₂O) | | | | | |

The test for moisture permeability is conducted by applying the aqueous dispersion of each embodiment onto a release paper with a dried film thickness of 20 μm. The sample is dried at 80° C. for 10 minutes, followed by further drying at 120° C. for 1 minute, so as to obtain a sheet material made from the aqueous dispersion for testing. The moisture permeability of the film is conducted according to A-1 method (calcium chloride method) of JIS L-1099-2012, with a water temperature of 23° C. and an external air temperature of 40±2° C. The water resistance test is conducted using the test method CNS 10460 L3201: 2007, 5.1 A2 method, with a water pressure increase rate of 60±3 cm H₂O/min. The waterproof resistance is tested at 2140 mm H₂O.

As shown in Table 1 above, the comparative example, which does not contain trifunctional polyether polyol PPG (P3000) and 1,4-cyclohexanedimethanol (CHDM), has higher water vapor permeability but the poorest water resistance. All of the embodiments 1 to 4 of the present disclosure contain bifunctional polyether polyol PPG (DL3000), bifunctional polyether polyol PTMG (PTMG2000), and trifunctional polyether polyol PPG (P3000), which may enhance the water resistance of the aqueous polyurethane.

It should be noted that, compared to embodiment 1, the amount of bifunctional polyether polyol PPG (DL3000) in embodiment 2 is reduced, so that although the moisture permeability is improved, the water resistance becomes worse. Embodiment 3 lacks 1,4-cyclohexanedimethanol (CHDM), which causes the water resistance to decrease even further. Embodiment 4 increases the amount of 1,4-cyclohexanedimethanol (CHDM), which raises the water resistance to 2571 mmH₂O, but also reduces the moisture permeability. Therefore, although 1,4-cyclohexanedimethanol (CHDM) may improve water resistance, it also needs to be added in a specific proportion to balance both moisture permeability and water resistance.

Further, the method for producing water-based moisture-permeable waterproof materials of the present disclosure includes step S10: adding kaolin to water-based polyurethane to form a resin mixture. In other words, the resin is made by adding kaolin into water-based polyurethane. Specifically, the method for producing water-based moisture-permeable waterproof materials of the present disclosure includes mixing the kaolin and the water-based polyurethane. Taking the aqueous polyurethane resin of embodiment 1 as an example, the effect of the mixing ratio of kaolin on viscosity (in cps) is shown in Table 2 below. The average of three repetitions is taken as the viscosity measurement.

TABLE 2

| | |
|---|---|
| Viscosity before mixing kaolin | Viscosity after mixing kaolin |

| | | |
|---|---|---|
| 8% | 1157 | 89950 |
| 5% | | 45000 |
| 3% | | 17000 |

From the Table 2 above, it can be observed that adding kaolin to the aqueous polyurethane increases the viscosity of the resin mixture, making the resin mixture suitable for the mechanical foaming process of the present disclosure. The method for producing water-based moisture-permeable waterproof materials of the present disclosure includes step S12: stirring the resin mixture to form pores in the resin mixture. Specifically, the resin mixture may be stirred at 1000 to 1200 rpm for 10 to 15 minutes. In one embodiment, the resin mixture may be stirred at 1200 rpm for 15 minutes.

It should be noted that, by adding kaolin, the viscosity of the resin mixture in the present disclosure is between 10,000 cps and 100,000 cps (for example, any integer value between 10,000 and 100,000), which allows for a more uniform pore distribution. Preferably, the viscosity of the resin mixture may range from 17,000 cps to 90,000 cps. In one embodiment, the size distribution of the coating pore ranges from 8.0 μm to 43 μm.

That is, the method for producing water-based moisture-permeable waterproof materials of the present disclosure includes further mixing 3% to 8% kaolin based on the total weight of the aqueous polyurethane. Further, taking the aqueous polyurethane resin of embodiment 1 as an example, the effect of adding kaolin on moisture permeability and water resistance is shown in Table 3 below. The moisture permeability and water resistance is taken from the average of three repetitions.

TABLE 3

| Kaolin addition amount (%) | 3 | 5 | 8 |
|---|---|---|---|
| moisture permeability | 3831 | 5477 | 6182 |
| (g/m²*24 hr) | | | |
| water resistance | 1316 | 1858 | 2140 |
| (mmH₂O) | | | |

From the Table 3 above, it can be observed that the moisture permeability and water resistance of the aqueous moisture-permeable waterproof material both increase with the addition amount of kaolin. It should be noted that, when the addition amount of kaolin is 8%, its effect on water vapor permeability and water resistance is the lowest. Therefore, in a preferred embodiment of the present disclosure, the addition amount of kaolin is 8% relative to the total weight of the aqueous polyurethane.

Finally, the method for producing the aqueous moisture-permeable waterproof material of the present disclosure further includes step S30: applying the resin mixture onto the substrate layer and performing the heat drying process. Specifically, the heat drying step may involve heating at 100° C. to 120° C. for 15 to 20 minutes. In one embodiment, the heat drying step may be heating at 120° C. for 15 minutes.

### Beneficial Effects of the Embodiments

In conclusion, in the method for producing water-based moisture-permeable waterproof and water-based moisture-permeable waterproof resin provided by the present disclosure, by virtue of “the water-based polyurethane including polyether polyols, isocyanates, and 1,4-cyclohexanedimethanol polymerized to form a polyurethane resin with a cyclic structure,” and “an addition amount of the kaolin being 3% to 8%,” the moisture-permeable waterproof properties of the resin material can be improved.

Further, in the method for producing water-based moisture-permeable waterproof materials and water-based moisture-permeable waterproof resin provided by the present disclosure introduces a cyclic structure into the polyol and reacts with isocyanates to synthesize polyurethane resin, which may improve the resin's water resistance. Furthermore, by utilizing resin's microporous structure, a moisture-permeable waterproof effect can be achieved. Additionally, both 1,4-cyclohexanedimethanol and polyether polyols have hydrophobic structures, which can further enhance water resistance, and micropores are generated through mechanical foaming to achieve the moisture-permeable waterproof effect.

Moreover, water-based polyurethane foam products do not contain volatile organic compounds (VOCs) such as DMF solvents, nor will there be any residual DMF precipitated. Therefore, in this foaming process, industrial wastewater from the wet coagulation process is not generated, thus eliminating the need for processes such as maintaining water tank levels, heating, and product washing. This reduces energy and water consumption, making the process for producing water-based moisture-permeable waterproof materials more sustainable and environmentally friendly.

In addition, kaolin is further added to the water-based polyurethane in the present disclosure, which further adjusts the viscosity of the water-based moisture-permeable waterproof resin, making the water-based moisture-permeable waterproof resin suitable for the mechanical foaming process of the present disclosure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for producing water-based moisture-permeable waterproof materials, comprising:
adding kaolin to a water-based polyurethane to form a resin mixture;
stirring the resin mixture to form pores in the resin mixture; and
applying the resin mixture onto a substrate layer and heat-drying the resin mixture;
wherein the water-based polyurethane comprises polyether polyols, isocyanates, and 1,4-cyclohexanedimethanol polymerized to form a polyurethane resin with a cyclic structure;
wherein an addition amount of the kaolin is 3% to 8%.

2. The method according to claim 1, wherein the resin mixture is stirred at a speed of 1000 to 1200 rpm for 10 to 15 minutes.

3. The method according to claim 1, wherein the heat-drying is performed at a temperature of 100° C. to 120° C. for 15 to 20 minutes.

4. A water-based moisture-permeable waterproof resin, comprising:
a water-based polyurethane including polyether polyols, isocyanates, and 1,4-cyclohexanedimethanol polymerized to form a polyurethane resin with a cyclic structure; and
a kaolin;
wherein an addition amount of the kaolin is 3% to 8%.

5. The water-based moisture-permeable waterproof resin according to claim 4, wherein a particle size (D90) distribution range of the water-based moisture-permeable waterproof resin is from 180 nm to 215 nm.

6. The water-based moisture-permeable waterproof resin according to claim 4, wherein a viscosity of the water-based moisture-permeable waterproof resin is between 10,000 cps and 100,000 cps.

7. The water-based moisture-permeable waterproof resin according to claim 4, wherein, based on a total weight of the water-based polyurethane being 100 wt %, the water-based polyurethane comprises:
20 wt % to 30 wt % of polyether polyol;
10 wt % to 15 wt % of isocyanate;
0.1 wt % to 2 wt % of 1,4-cyclohexanedimethanol;
1 wt % to 2 wt % of 2,2-dihydroxyethylacrylate;
0.5 wt % to 1 wt % of chain extender;
1 wt % to 2 wt % of triethylamine; and
50 wt % to 65 wt % of water.

8. The water-based moisture-permeable waterproof resin according to claim 7, wherein the isocyanate is a diisocyanate, and the diisocyanate is selected from the group consisting of toluene diisocyanate (TDI), isophorone diisocyanate (IPDI), methylene diphenyl diisocyanate (MDI), and hexamethylene diisocyanate (HMDI).

9. The water-based moisture-permeable waterproof resin according to claim 7, wherein a molecular weight of the polyether polyol is between 200 g/mol and 6000 g/mol.

10. The water-based moisture-permeable waterproof resin according to claim 7, wherein the chain extender is selected from the group consisting of ethylenediamine, hexamethylenediamine, xylenediamine, isophoronediamine, diethylenetriamine, and N-aminoethyl-N-ethanolamine.
